(19) United States
(12) Patent Application Publication
(10) Pub. No.: US 2016/0311345 A1
(43) Pub. Date: Oct. 27, 2016

(54) METHOD AND APPARATUS FOR VEHICLE SEAT BELT TENSIONING FOR A CHILD CAR SEAT

(71) Applicant: GRACO CHILDREN'S PRODUCTS INC., Atlanta, GA (US)

(72) Inventor: Matthew Alan Morgenstern, West Chester, PA (US)

(21) Appl. No.: 15/137,329

(22) Filed: Apr. 25, 2016

Related U.S. Application Data
(60) Provisional application No. 62/152,585, filed on Apr. 24, 2015.

(51) Int. Cl. B60N 2/28; B60R 22/30; B60R 22/10

(52) U.S. Cl. CPC B60N 2/2806; B60R 22/105; B60R 22/30; B60N 2002/2815

(57) ABSTRACT

A seat belt tensioning apparatus can be incorporated into or coupled to a child car seat, such as a child car seat base, a forward-facing child car seat, a rearward facing child car seat, or a toddler seat, to provide additional tensioning of a vehicle seat belt. The seat belt tensioning apparatus can include a belt lock-off device that is configured to grip and hold a portion of a vehicle seat belt and move along a belt pathway when the child car seat is placed upon the top surface of a vehicle seat. The seat belt tensioning apparatus can also include an actuator operably coupled to the belt lock-off device and configured to move the belt lock-off device in one or two directions along the belt pathway to apply additional tension to a vehicle seat belt captured in the belt lock-off device.

### CROSS-REFERENCE TO RELATED APPLICATION

This application claims priority under 35 U.S.C. §119 to U.S. Provisional Patent Application No. 62/152,585 filed Apr. 24, 2015, and titled “Child Car Seat Belt Tensioner,” the entire contents of which are hereby incorporated herein by reference for all purposes.

### TECHNICAL FIELD

The present disclosure is generally directed to seat belt tensioners and more specifically to a seat belt tensioner for securing a children's car seat or car seat base to a vehicle seat.

### BACKGROUND

A typical child car seat is installed on the seat bottom of a dedicated seat in a vehicle (e.g., automobile, airplane, etc.). Certain versions of the child car seat can have a separate base to which a seat portion or carrier is then removably coupled to and decoupled from. Other versions of the child car seat can be a stand-alone car seat or booster that mounts directly to the vehicle seat. Some conventional child car seats include a separate anchor belt that connects and latches to fixed anchor points provided within the vehicle on or adjacent to the dedicated vehicle seat. The anchor belt, once latched and secured, can be tightened to securely hold the child car seat or child car seat base in place on the dedicated vehicle seat. Other conventional child car seats use the vehicle's dedicated safety harness or restraint system (e.g., seat belts) to secure the child car seat base or the child car seat to the vehicle seat. Typically, the vehicle's seat belt will include an automatic harness tensioner that is relied upon to hold the child car seat or child car seat base in place on the vehicle seat.

FIG. 1 shows one example of a conventional child car seat base 100 to which a child car seat, such as an infant carrier, may be removably coupled in a number of ways known in the art. In one example, infant carriers (not shown) can be removably coupled to this type of child car seat base 100. The base 100 is typically mounted to the vehicle's dedicated seat (not shown) and then the seat portion or infant carrier is mounted on top of the base 100. The conventional base includes a molded seat shell frame 105. The molded seat shell frame 105 is typically made from plastic or other similar materials. The molded seat shell frame 105 includes a belt pathway 110 configured to receive a vehicle seat belt 125 thereon. In one example, the belt pathway 110 is wider than the vehicle seat belt 125 and has a generally smooth and rounded surface to permit the seat belt to slide along the belt pathway 110. The molded seat shell frame 105 of the child car seat base 100 can also include a first belt path opening 115 that provides a passageway for the vehicle seat belt 125 to enter the belt pathway 110 from an outside of the molded frame 110. The molded seat shell frame 105 can also include a second belt path opening 120 that provides a passageway for the vehicle seat belt 125 to exit the belt pathway 110 and extend outside of the molded seat shell frame 105 so that a latch plate (not shown) on an end of the vehicle seat belt 125 can be removably coupled to a latch anchored to the vehicle and/or the vehicle seat. In another embodiment, the roles of the first belt path opening 115 and second belt path opening 120 are reversed depending on the location of the base 100 in the vehicle and the location of the vehicle seat belt 125 and latch.

However, the vehicle's seat belt system 125 is or can be relatively slack even when the child car seat base 100 or child car seat is completely and properly installed and the spring return of the seat belt system 125 is operating properly. This slack in the vehicle seat belt 125 can allow the child car seat base 100 and/or the child car seat to move or slide around, thereby reducing the effectiveness of the safety provided to a child in the child car seat, infant carrier, or toddler seat held in place by the vehicle's seat belt system 125.

### BRIEF DESCRIPTION OF THE DRAWINGS

Reference will now be made to the accompanying drawings, which are not necessarily drawn to scale, and wherein:

FIG. 1 illustrates one example of a conventional child car seat base for a child car seat, such as an infant carrier.

FIGS. 2A-2D illustrate multiple views of a vehicle seat belt tensioning apparatus constructed according to one example embodiment of the disclosure.

FIGS. 3A-3I illustrate an example method for tensioning a vehicle seat belt using a vehicle seat belt tensioning apparatus according to one example embodiment of the disclosure.

FIG. 4 illustrates the vehicle seat belt tensioning apparatus incorporated into a child car seat base according to one example embodiment of the disclosure.

FIG. 5 illustrates the vehicle seat belt tensioning apparatus incorporated into a child car seat according to one example embodiment of the disclosure.

FIG. 6 illustrates another vehicle seat belt tensioning apparatus according to another example embodiment of the disclosure.

### DETAILED DESCRIPTION OF EXAMPLE EMBODIMENTS

Exemplary embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Certain dimensions and features of the example seat belt tensioning apparatus are described herein using the term “approximately.” As used herein, the term “approximately” indicates that each of the described dimensions is not a strict boundary or parameter and does not exclude functionally similar variations therefrom. Unless context or the description indicates otherwise, the use of the term “approximately” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

In addition, certain relationships between dimensions of the example seat belt tensioning apparatus and between features of the example seat belt tensioning apparatus are described herein using the term “substantially.” As used herein, the terms “substantially” and “substantially equal” indicates that the equal relationship is not a strict relationship and does not exclude functionally similar variations therefrom. Unless context or the description indicates otherwise, the use of the term “substantially” or “substantially equal” in connection with two or more described dimensions indicates that the equal relationship between the dimensions includes variations that, using mathematical and industrial principles accepted in the art (e.g., rounding, measurement or other systematic errors, manufacturing tolerances, etc.), would not vary the least significant digit of the dimensions. As used herein, the term “substantially constant” indicates that the constant relationship is not a strict relationship and does not exclude functionally similar variations therefrom. As used herein, the term “substantially parallel” indicates that the parallel relationship is not a strict relationship and does not exclude functionally similar variations therefrom. As used herein, the terms “substantially perpendicular” and “substantially orthogonal” indicate that the perpendicular relationship is not a strict relationship and does not exclude functionally similar variations therefrom.

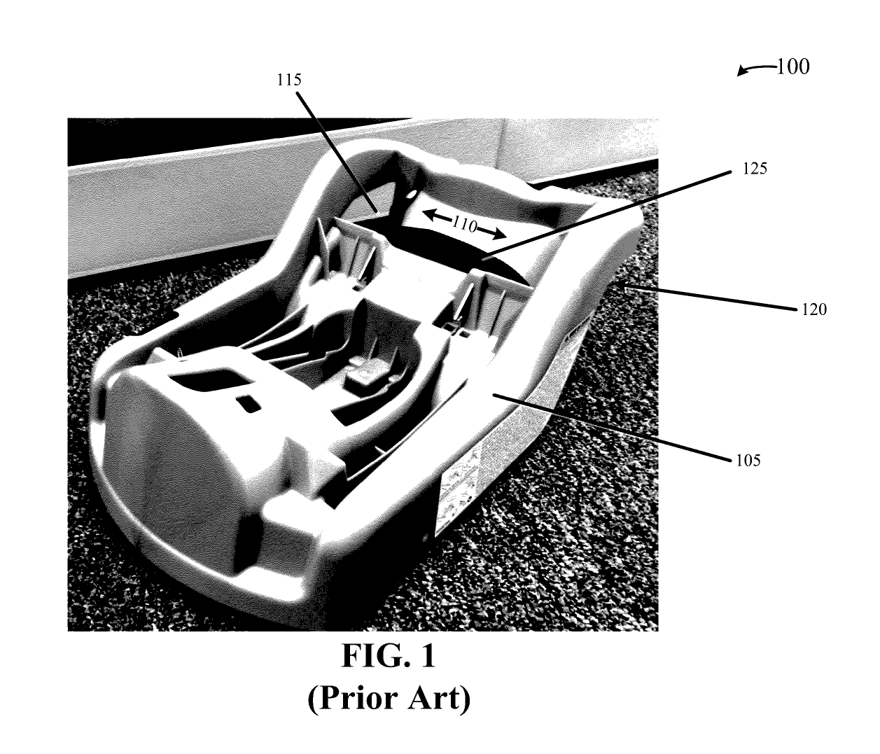

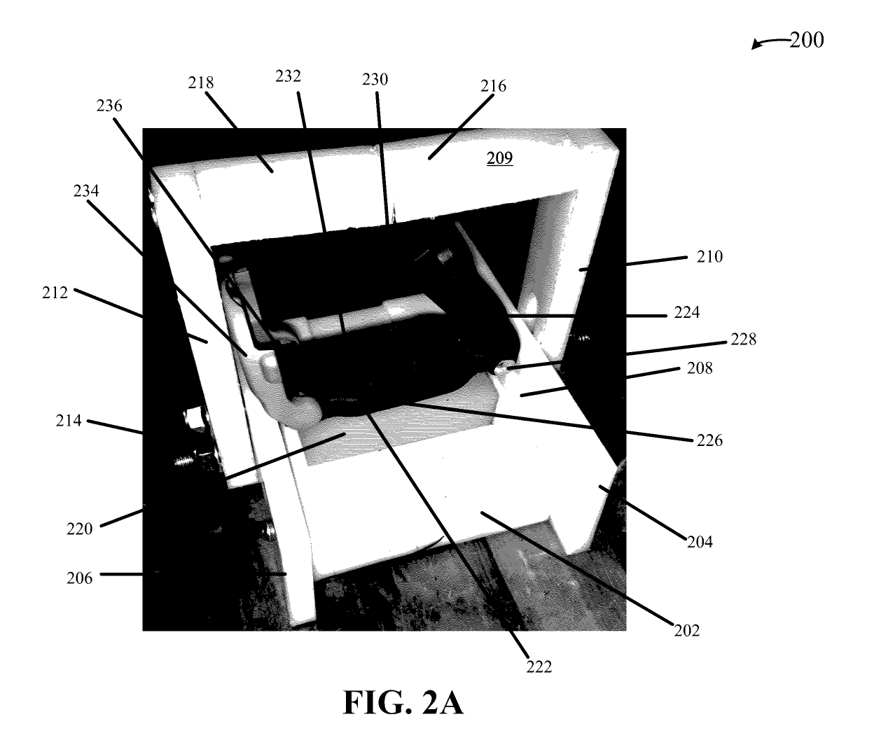

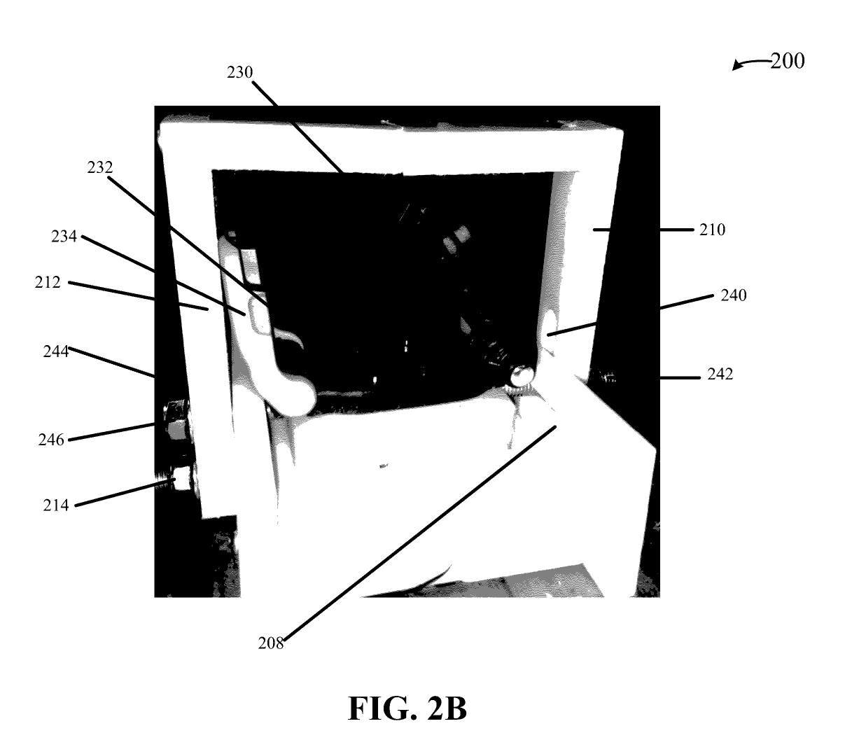

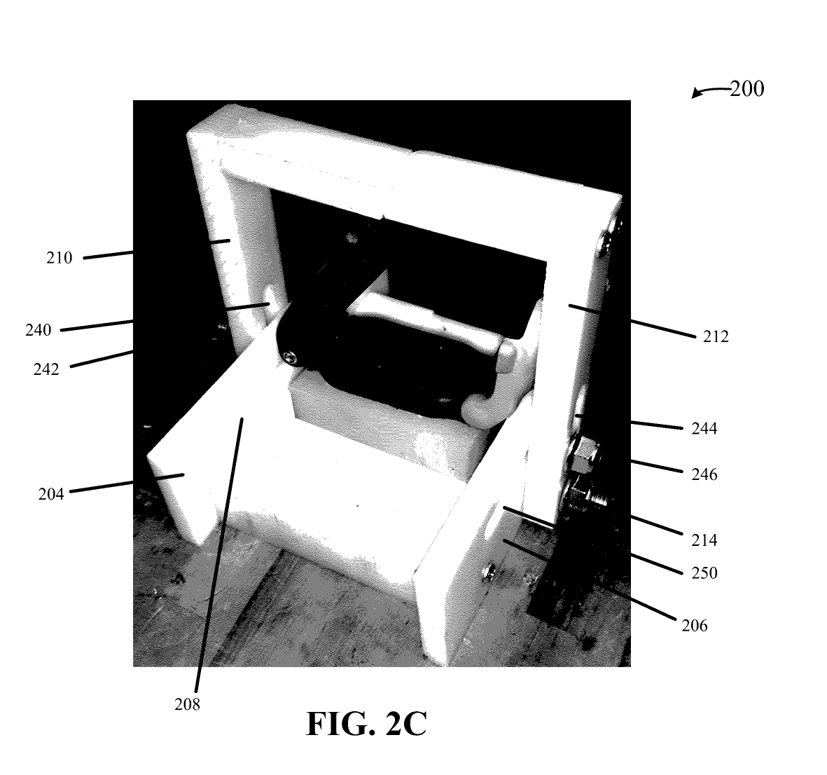

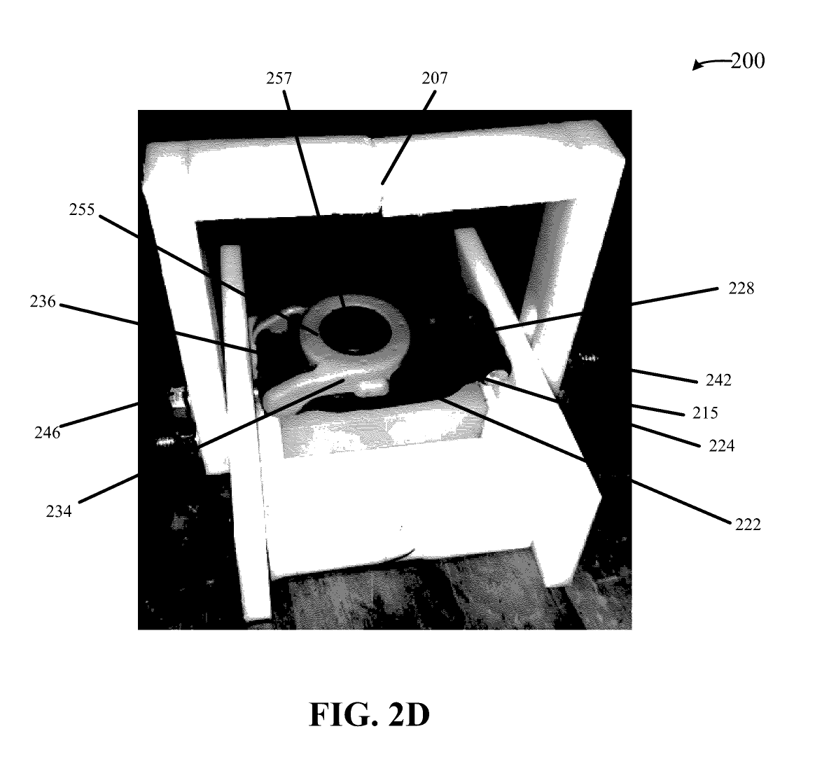

FIGS. 2A-2D illustrate multiple views of an example vehicle seat belt tensioning apparatus 200 constructed according to one example embodiment of the disclosure. Referring now to FIGS. 1 and 2A-2D, the example vehicle seat belt tensioning apparatus 200 can include a base member 202. The example base member 202 can include a first end, a distal second end, a first lateral side and a second lateral side. A line or arc (in embodiments where the top surface is not flat) connecting the first end to the distal second end can define a belt pathway for the seat belt tensioning apparatus 200. The base member 202 can have a longitudinal axis that extends from the first end to the distal second end and is parallel or substantially parallel to the belt pathway for a vehicle seat belt 125. The base member 202 can include a flat or substantially flat top surface. Alternatively, the base member 202 can have an arced or curved top surface that extends between all or at least a portion of the distance between the first end and the distal second end. In another alternate embodiment, the base member 202 can include one or more grooves extending along the longitudinal axis or top surface profile of the base member 202 that can act as tracts for maintaining a sliding direction of a corresponding lock-off base member 220 along the longitudinal axis of the base member 202. In one example embodiment, the base member 202 can be made of metal or plastic, such as polypropylene or other plastics known to those of ordinary skill in the art.

The vehicle seat belt tensioning apparatus 202 can also include a first side member 204 coupled to the base member 202. In one example, the first side member 204 can be coupled to the base member 202 along the first lateral side of the base member and can have a longitudinal axis that extends parallel or substantially parallel to the longitudinal axis of the base member 202. In certain example embodiments, the first side member 204 can include an elongated slot 208 that provides an aperture through the first side member 204. In one example, the elongated slot 208 can extend along at least a portion of the longitudinal axis of the first side member 204. While the example elongated slot 208 is shown as being straight or substantially straight and extending along a longitudinal axis parallel to the longitudinal axis of the base member 202, in an alternate embodiment, the elongated slot 208 can be curved and/or have a matching profile (e.g., parallel or substantially parallel profile) to the top surface profile of the base member 202, such as when the top surface of the base member 202 is curved and has a curved top surface profile extending between the first end and the second end of the base member. In one example embodiment, at least a portion of the first side member 204 extends above a top surface of the base member 202. In this example, the elongated slot 208 is provided on the portion of the first side member 204 that extends above the top surface of the base member 202.

The vehicle seat belt tensioning apparatus 202 can also include a second side member 206 coupled to the base member 202. In one example, the second side member 206 can be coupled to the base member 202 along the second lateral side of the base member and can have a longitudinal axis that extends parallel or substantially parallel to the longitudinal axis of the base member 202. In certain example embodiments, the second side member 206 can include an elongated slot 250 that provides an aperture through the second side member 206. In one example, the elongated slot 250 can extend along at least a portion of the longitudinal axis of the second side member 206. While the example elongated slot 250 is shown as being straight or substantially straight and extending along a longitudinal axis parallel to the longitudinal axis of the base member 202, in an alternate embodiment, the elongated slot 250 can be curved and/or have a matching profile (e.g., parallel or substantially parallel profile) to the top surface profile of the base member 202, such as when the top surface of the base member 202 is curved and has a curved top surface profile extending between the first end and the second end of the base member. In one example embodiment, at least a portion of the second side member 206 extends above a top surface of the base member 202. In this example, the elongated slot 250 is provided on the portion of the second side member 206 that extends above the top surface of the base member 202.

While the example embodiment disclosed describes a base member 202 and side members 204, 206 coupled to the base member 202, in an alternative embodiment, the base member 202 and side members 204, 206 may be integrally formed as a single unitary piece.

The vehicle seat belt tensioning apparatus 202 can also include an actuator or adjustment handle 209 rotatably coupled to the base member 202, the first side member 204 and/or the second side member 206. In one example, the adjustment handle 209 includes a first adjustment handle arm 210, a first handle grip 216, a second adjustment handle arm 212 and a second handle grip 218. In one example embodiment, the actuator or adjustment handle 209 is configured to adjust the position of a belt lock-off device 222 along the longitudinal axis of the base 202 and along a seat belt pathway. While the example embodiment described herein primarily discusses an adjustment handle 209, any other form of actuator configured to move a belt lock-off device along the longitudinal axis of the base 202 and along the belt pathway can alternatively be used.

In one example, the adjustment handle 209 include a split grip 302 that splits the grip of the adjustment handle into the first handle grip 216 and the second handle grip 218. In one example, the split grip 207 creates a slot in the handle for the user to easily pass the shoulder strap of a vehicle seat belt 125 through the split in the handle, if and when needed. In example embodiments where the handle grip include a split grip 207, the handle grips could further include a spring loaded, carabiner-like, closure to auto close the split 207 unless the opening caused by the split is needed to pass a portion of the vehicle seat belt 125, such as the sash or shoulder belt portion through the split grip 207. In another example embodiment, the first handle grip 216 and the second handle grip 218 are a single piece that forms a single, un-split handle grip for the adjustment handle 209. Further, while the example embodiment of FIGS. 2A-2D show the handle 209 coupled along both lateral sides of the base member 202, in an alternative embodiment, the handle 209 may only be coupled along one lateral side of the base member 202. In this example embodiment, the handle may include a single adjustment handle arm and handle grip.

In one example embodiment, the first adjustment handle arm 210 can include a longitudinal member having a first end and a distal second end. The first adjustment handle arm 210 can be rotatably coupled to the base member 202 and/or the side member 204 adjacent the first end of the longitudinal member with a pivot coupling means 215 (such as a bolt, axle, bearing shaft, or the like). The pivot coupling means 215 can define an axis of rotation for the first adjustment handle arm 210.

In certain example embodiments, the first adjustment handle arm 210 can include a spring or other biasing mechanism to bias the first adjustment handle arm 210 into a first or initial position. In one example, the spring or other biasing mechanism can be coupled adjacent the first end of the longitudinal member and may be incorporated into or included alongside the pivot coupling means 215. Examples of the spring or other biasing mechanism can include a tension spring or a torsion spring. In one example, the initial position for the first adjustment handle arm 210 may be a center position and the arm 210 may be rotatable to the right and/or to the left of the center position and configured to be biased back to the center position when not locked in place. In other example embodiments, the seat belt tensioning apparatus 200 could have only two positions, an initial position and a locked or belt tensioning position, but could be rotatable or reversible on the child car seat or child car seat base to which the seat belt tensioning apparatus 200 is attached or incorporated into, to accommodate a particular vehicle seat mounting orientation.

In certain example embodiments, the first adjustment handle arm 210 can also include an elongated slot 240 that provides an aperture through the first adjustment handle arm 210 and that extends along at least a portion of the longitudinal axis of the first adjustment handle arm 210. In one example embodiment, at least a portion of the elongated slot 240 aligns with at least a portion of the elongated slot 208 in the first side member 204, such that a guide pin 242 can extend through the elongated slot 240 and the elongated slot 208 and a first end of the guide pin 242 can be coupled to a first end of the lock-off base member 222 and/or the first end of the belt lock-off device 222. The guide pin 242 can be a pin, bolt, screw, nail, or any other straight, rigid member. At least a portion of the guide pin 242 is configured to slide within and along the elongated slot 240 and the elongated slot 208 in response to rotation of the first adjustment handle arm 210. The movement of the guide pin 242 along the elongated slots 240 and 208 causes a corresponding lateral movement of the belt lock-off device 222 and optionally the lock-off base 220 along the belt pathway 110 and the longitudinal axis of the base member 202. The guide pin 242 can further include a cap, such as the head of bolt, screw, nail, nut or wingnut, disposed along a portion of the guide pin 242 adjacent the second end of the guide pin 242 and configured to prevent the guide pin 242 from coming out of the elongated slot 240 and/or the elongated slot 208.

A first handle grip 216 can be coupled to (using known coupling devices) or integrally formed with the first adjustment handle arm 210 at or adjacent to the second end of the longitudinal member. In one example, the first handle grip 216 can extend orthogonal or substantially orthogonal to the longitudinal axis of the first adjustment handle arm 210 and can have an ergonomic shape for being gripped by the hand of a user.

In one example embodiment, the second adjustment handle arm 212 can include a longitudinal member having a first end and a distal second end. The second adjustment handle arm 212 can be rotatably coupled to the base member 202 and/or the second side member 206 adjacent the first end of the longitudinal member with a pivot coupling means 214 (such as a bolt, axle, bearing shaft, or the like). The pivot coupling means 214 can define an axis of rotation for the second adjustment handle arm 212. In certain example embodiments, the second adjustment handle arm 212 can include a spring or other biasing mechanism to bias the second handle adjustment arm 212 into a first or initial position. In one example, the spring or other biasing mechanism can be coupled adjacent the first end of the longitudinal member and may be incorporated into or included alongside the pivot coupling means. Examples of the spring or other biasing mechanism can include a tension spring or a torsion spring. In one example, the initial position for the second adjustment handle arm 212 may be a center position and the arm 212 may be rotatable to the right and/or to the left of the center position and configured to be biased back to the center position when not locked in place.

In certain example embodiments, the second adjustment handle arm 212 can also include an elongated slot 244 that provides an aperture through the second adjustment handle arm 212 and that extends along at least a portion of the longitudinal axis of the second adjustment handle arm 212. In one example embodiment, at least a portion of the elongated slot 244 aligns with at least a portion of the elongated slot 250 in the second side member 206, such that a guide pin 246 can extend through the elongated slot 244 and the elongated slot 250 and a first end of the guide pin 246 can be coupled to a second end of the lock-off base member 222 and/or the second end of the belt lock-off device 222. The guide pin 246 can be a pin, bolt, screw, nail, or any other straight, rigid member. At least a portion of the guide pin 246 is configured to slide within and along the elongated slot 244 and the elongated slot 250 in response to rotation of the second adjustment handle arm 212. The movement of the guide pin 246 along the elongated slots 244 and 250 causes a corresponding lateral movement of the belt lock-off device 222 and optionally the lock-off base 220 along the belt pathway 110 and the longitudinal axis of the base member 202. The guide pin 246 can further include a cap, such as the head of bolt, screw, nail, nut or wingnut, disposed along a portion of the guide pin 242 adjacent the second end of the guide pin 242 and configured to prevent the guide pin 246 from coming out of the elongated slot 244 and/or the elongated slot 250.

A second handle grip 218 can be coupled to (using known coupling devices) or integrally formed with the second adjustment handle arm 212 at or adjacent to the second end of the longitudinal member. In one example, the second handle grip 218 can extend orthogonal or substantially orthogonal to the longitudinal axis of the second adjustment handle arm 212 and can have an ergonomic shape for being gripped by the hand of a user.

The vehicle seat belt tensioning apparatus 202 can also include a lock-off base member 220 disposed along a top surface of the base member 202. In one example embodiment, the lock-off base member 220 is configured to slide or otherwise move along the top surface of the base member 202 along the belt pathway (e.g., the longitudinal axis or top surface profile in examples where the top surface of the base member 202 is flat or flat and grooved, along the top surface profile between the first end and the second end of the base member 202 in examples where the top surface is curved or curved and grooved) of the base member 202. The lock-off base member 220 can include a flat or substantially flat top surface and an opposing bottom surface. In example embodiments where the base member 202 includes grooves along the top surface of the base member 202, the lock-off base member 220 may include one or more corresponding protrusions extending out from a bottom surface of the lock-off base member 220 that are configured to fit within the grooves of the base member 202 and limit or prevent movement of the lock-off base member 220 towards either of the first side member 204 or second side member 206 in example embodiments where the top surface of the base member 202 is curved, the bottom surface of the lock-off base member 220 may have a corresponding/concentrically curved bottom surface.

In one example embodiment, a belt lock-off device 222 can be coupled to the lock-off base member 220 using known coupling devices (e.g., screws, nails, bolts, rivets, adhesive, etc.). In another example embodiment, the features and actions of the lock-off base member 220 can be incorporated into the belt lock-off device 222. The belt lock-off device 222 and the lock-off base member 220 can be configured to slide along the belt path, which is provided along the longitudinal axis of the base member 202.

In certain example embodiments, the belt lock-off device 222 includes a receiving member 226, a clamping member 224, and a locking member 234. The receiving member 222 can be static with respect to the lock-off base member 220 and can include a bottom surface and opposing top surface. The bottom surface of the receiving member can abut the top surface of the lock-off base member 220 or alternatively the top surface of the base member 202 when the belt lock-off device 222 and lock-off base member 220 are combined. The top surface of the receiving member 226 can include a flat or substantially flat surface and one or more recessed grooves 232 in the flat or substantially flat top surface. Each recessed groove 232 can extend along all or at least a portion of the top surface of the receiving member 226 from a first end of the receiving member 226 towards a second end of the receiving member 226. In one example, the one or more recessed grooves 232 each extend along a line orthogonal or substantially orthogonal to the belt pathway 110 and the longitudinal axis of the base member 110. In one example embodiment, the top surface of the receiving member 226 is configured to receive at least a portion of a vehicle seat belt 125 thereon.

The clamping member 224 can be rotatably coupled to the first end of the receiving member 226, adjacent the first side member 204, with a first rotating hinge 228. The clamping member 226 can include a top surface and an opposing bottom surface. The top surface of the clamping member 226 can include a locking tab 257. In one example, the locking tab 257 has a circular or substantially circular shape and extends up from the top surface of the clamping member 226. The bottom surface of the clamping member 226 can include a flat or substantially flat surface and one or more elongated protrusions or tongues 230 extending out from the flat or substantially flat surface. In one example, the one or more elongated protrusions or tongues 230 each extend along a line orthogonal or substantially orthogonal to the belt pathway 110 and the longitudinal axis of the base member 110.

In one example, the clamping member 224 is configured to be adjusted from an open configuration (see FIG. 2A) to a closed configuration (see FIG. 2D) by rotating about an axis of rotation defined by the first hinge member 228. In one example, the first hinge member 228 and/or the clamping member 224 can include a spring or other biasing mechanism to bias the clamping member 224 in the open configuration. Examples of the spring or other biasing mechanism can include a tension spring or a torsion spring incorporated into the first hinge member 228. In the closed configuration, at least a portion of each protrusion 230 is configured to extend at least partially into at least a portion of a corresponding groove 232 in the top surface of the receiving member 226. In addition, the flat or substantially flat bottom surface of the clamping member 224 can be configured to abut the flat or substantially flat top surface of the receiving member 232 to trap, grip, or hold at least a portion of a vehicle seat belt disposed along the top surface of the receiving member 232. In certain example embodiments, each of the top surface of the receiving member 226 and the bottom surface of the clamping member 224 can include a friction enhancing material layer, such as a rubber, silicone, or other material with a tacky surface.

The locking member 234 can be rotatably coupled to the second end of the receiving member 226, adjacent the second side member 206, with a second rotating hinge 236. The locking member 234 can a first arm rotatably coupled to the hinge 236 and a second arm coupled to the hinge 236. The locking member 234 can also include a tab receiving aperture 255 that is sized and shaped to receive at least a portion of a corresponding locking tab 257 in a locked configuration. In one example, the locking member 234 is configured to be adjusted from an open/unlocked configuration (see FIG. 2A) to a locked configuration (see FIG. 2D) by rotating about an axis of rotation defined by the second hinge member 236. In one example embodiment, the tab receiving aperture 255 receives at least a portion of the locking tab 257 with an interference fit or friction fit to lock the clamping member 224 in the closed configuration. In addition, the clamping member 224 may further include a lock release lever operable coupled to the locking tab and configured to release the locking member 234 from the clamping member 224 and allow the locking member 234 to return to the open/unlocked configuration by rotation about the second hinge member 236. In one example, the second hinge member 236 and/or the locking member 234 can include a spring or other biasing mechanism to bias the locking member 234 in the open/unlocked configuration. Examples of the spring or other biasing mechanism can include a tension spring or a torsion spring incorporated into the second hinge member 236. When the locking member 234 is released from the locked configuration and returns to the open/unlocked configuration, the clamping member 224 can also rotate about the first hinge member 228 from the closed configuration to the open configuration.

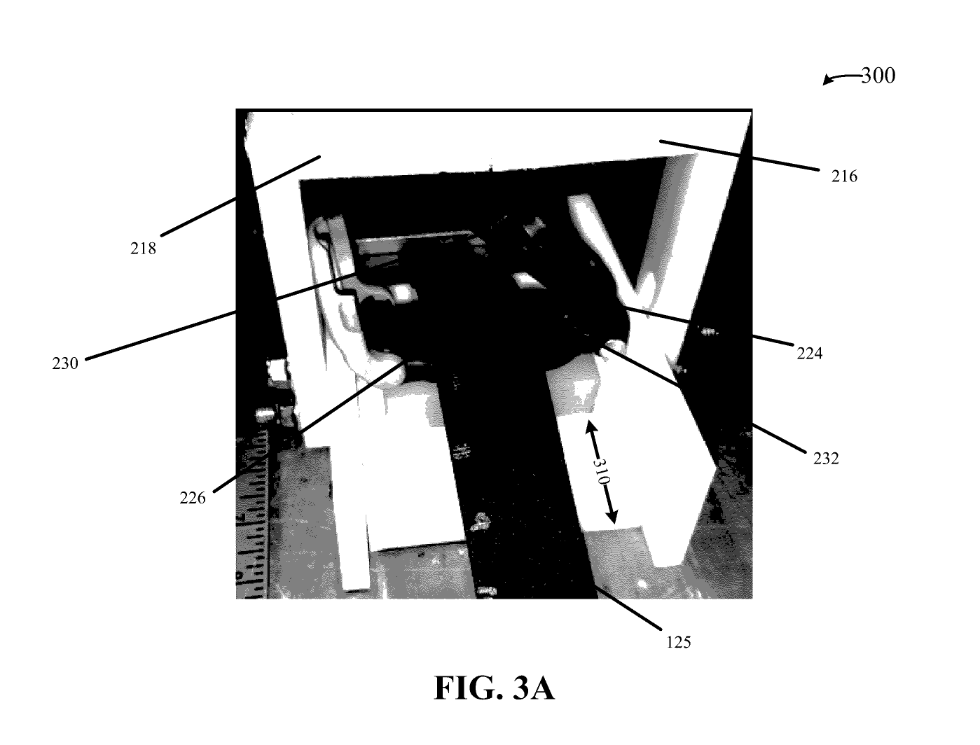

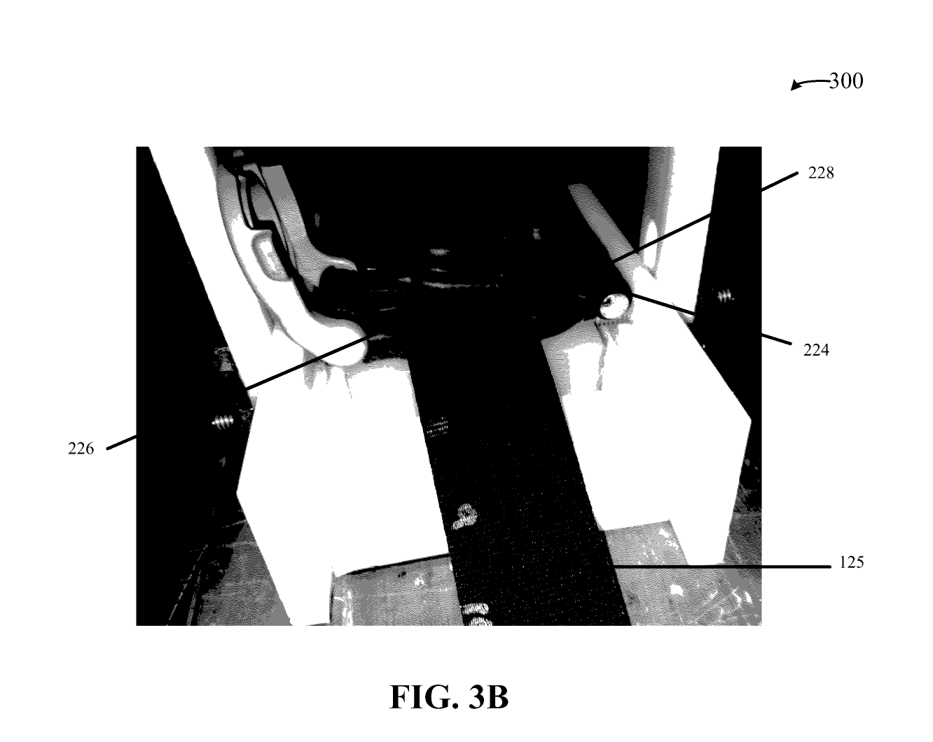

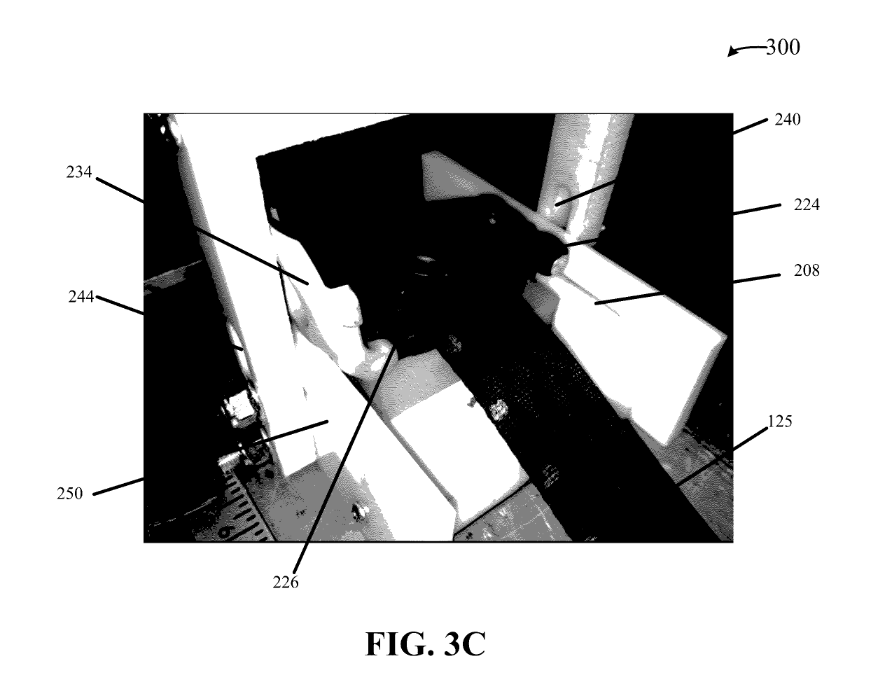

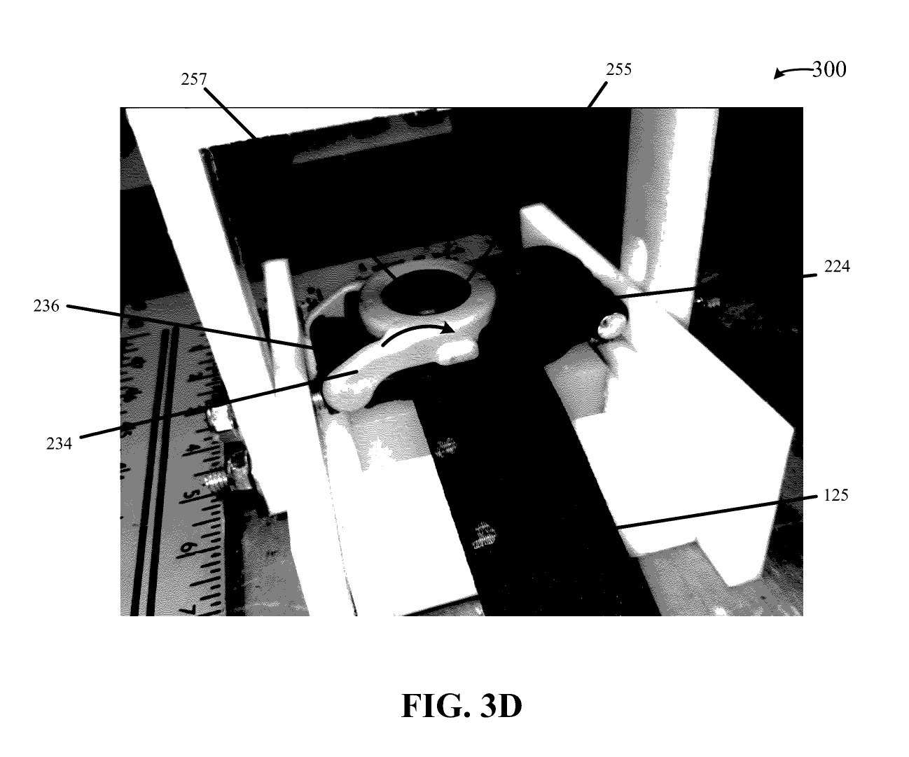

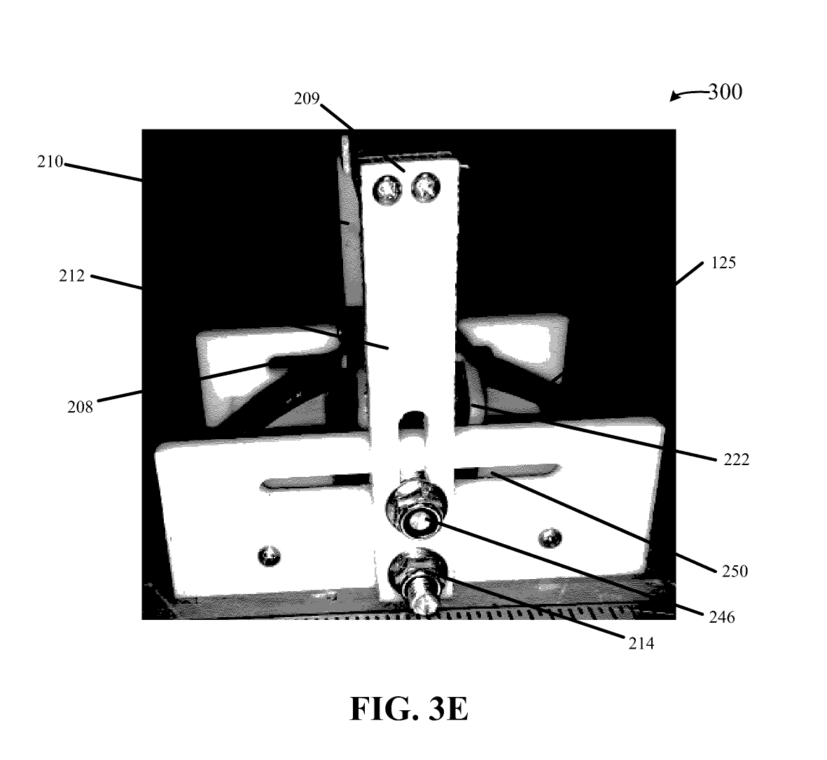

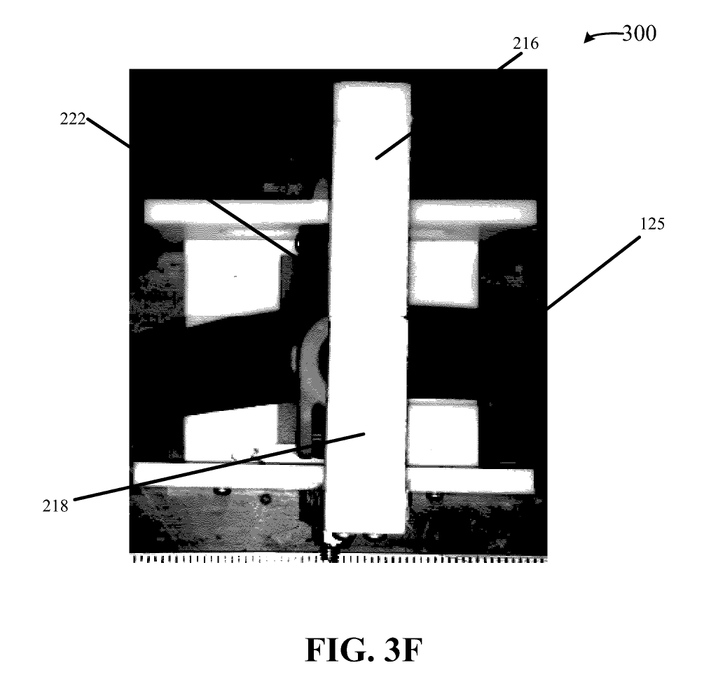

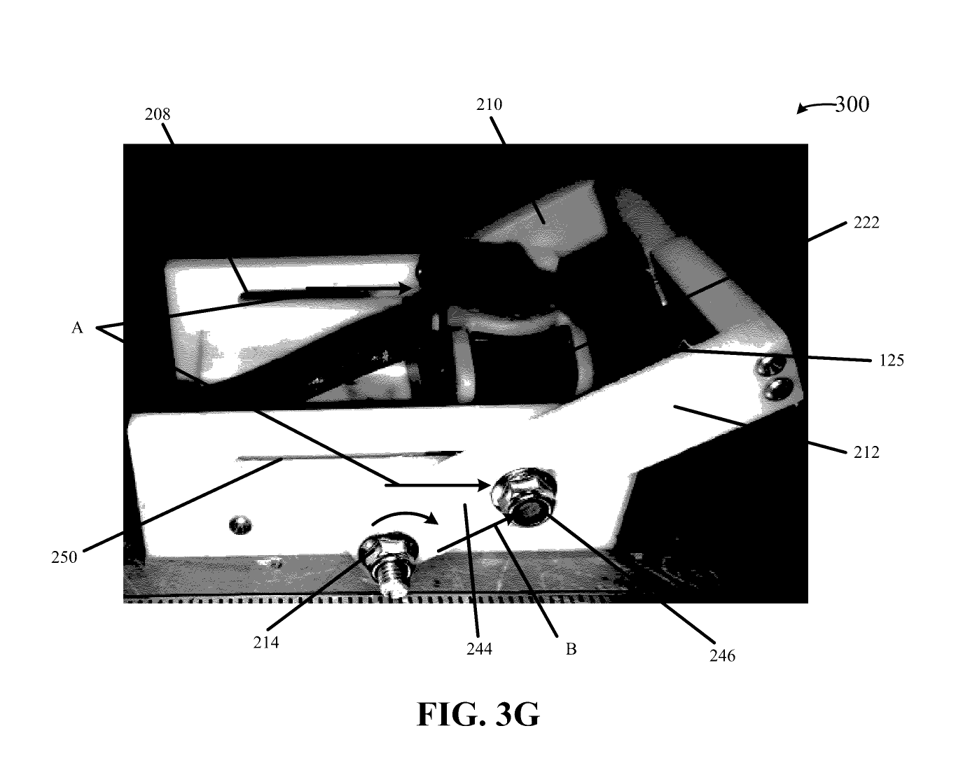

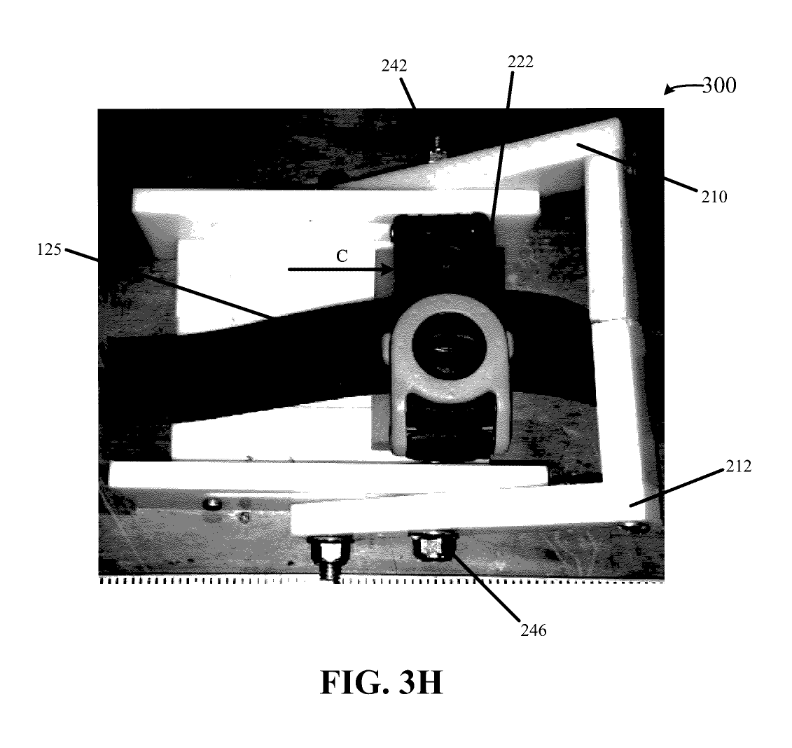

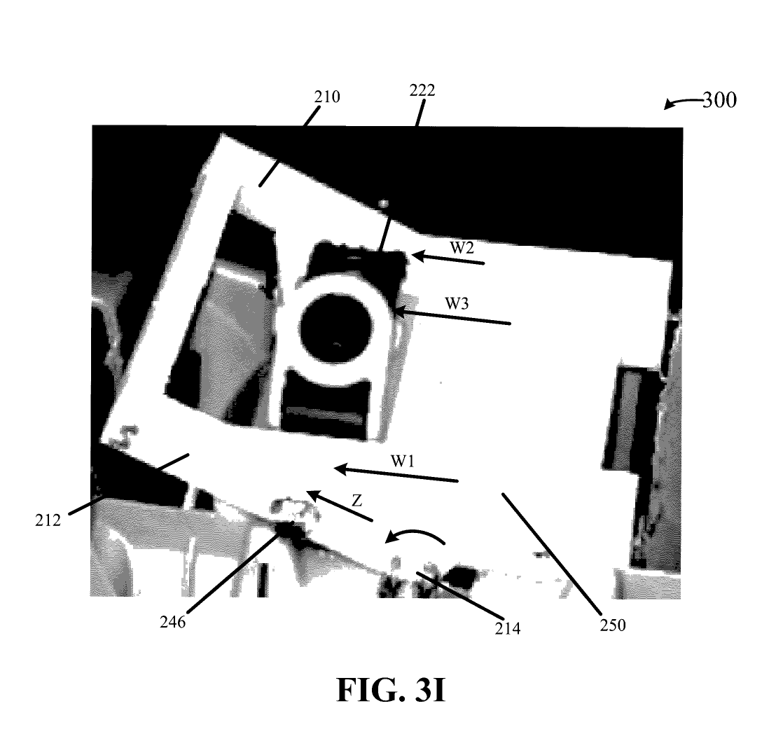

FIGS. 3A-3I illustrate an example method 300 for tensioning a vehicle seat belt 125 using a vehicle seat belt tensioning apparatus 200 according to one example embodiment of the disclosure. Referring now to FIGS. 2A-3I, the example method 300 begins by positioning the child car seat or child car seat base that includes the seat belt tensioning apparatus 200 along the top surface of a seat bottom of the dedicated vehicle seat. Further, as shown in FIG. 3A, at least a portion of the vehicle seat belt 125 can be placed across at least a portion of the top surface of the receiving member 226 of the belt lock-off device 222 in the belt pathway 310. In one example, the vehicle seat belt 125 is placed over the portion of the top surface of the receiving member 226 that includes the recessed groove 232, such that at least a portion of the belt 125 extends across the recessed groove 232. In an example embodiment where the vehicle seat belt 125 is a three-point seat belt that includes a lap belt portion and a sash belt portion, the lap belt portion is placed over the top surface of the receiving member 226. In another example embodiment, where the vehicle seat belt 125 is a two-point seat belt that includes a lap belt, then the lap belt is placed over the top surface of the receiving member.

Next, as shown in FIGS. 3B-3C, a user can apply a force normal to the top surface of the clamping member 224 of the belt lock-off device 222 to cause the clamping member 224 to rotate about the first rotating hinge member 228 from an open configuration towards a closed configuration while the vehicle seat belt remains across the top surface of the receiving member 226. In one example, the force must be greater than the spring biasing force along the first rotating hinge member 228 that biases the clamping member 224 in the open configuration. As the clamping member 224 is rotated from the open configuration towards the closed configuration, the elongated protrusion 230 extending out from the bottom surface of the clamping member 224 will abut a top surface of the vehicle seat belt 125 and force at least a portion of the vehicle seat belt 125 into the elongated recessed groove 232 in the top surface of the receiving member 226. The clamping member 224 will continue to be rotated into the closed configuration until the bottom surface of the clamping member 224 abuts a top surface of the vehicle seat belt 125 and the top surface of the receiving member 226 abuts the bottom surface of the vehicle seat belt 125 with the elongated protrusion 230 at least partially extending into the elongated recessed groove 232 to trap and hold the vehicle seat belt 125 in a non-slip manner.

As shown in FIG. 3D, a user can apply a force normal to the top surface of the locking member 234 of the belt lock-off device 222 to cause the locking member 234 to rotate about the second rotating hinge member 236 from an unlocked configuration towards a locked configuration. In one example, the force must be greater than the spring biasing force along the second rotating hinge member 236 that biases the locking member 234 in the unlocked configuration. As the locking member 234 is rotated from the unlocked configuration towards the locked configuration the tab receiving aperture 255 of the locking member 234 extends over at least a portion of the locking tab 257 extending up from the top surface of the clamping member 224 and at least a portion of the locking tab 257 passes through the tab receiving aperture 255 until an interference fit locks the locking member 234 over the clamping member 224 and locking the clamping member 224 in the closed configuration with respect to receiving member 226. In another example embodiment, another locking mechanism can be incorporated into the belt lock-off device such that the clamping member 224 directly locks to the receiving member 226 in the closed configuration.

In another example embodiment function of moving the clamping member 224 from the open configuration to the closed configuration and/or moving the locking member 234 from the unlocked to the locked position can be accomplished and integrated into the motion of the adjustment handle 209, such that the capture and locking of the belt lock-off device 222 is not a separate function but instead would occur automatically when the adjustment handle 209 is moved from the initial position in either the clockwise or counter-clockwise direction before then adding tension to the vehicle seat belt 125. In other words, moving the adjustment handle 209 in either the clockwise or counter-clockwise direction from the initial position would first capture the vehicle seat belt 125 in the belt lock-off device 222 and then, continuing to move the adjustment handle 209, would apply tension to the vehicle seat belt 125 by moving the belt lock-off device along the belt pathway 310 with the captured belt 125.

FIGS. 3E and 3F illustrate the adjustable handle 209 in the initial or centered position with the guide pin 246 substantially centered along the longitudinal axis of the elongated slot 250 and the guide pin 242 substantially centered along the longitudinal axis of the elongated slot 208, with the belt lock-off device 222 in the locked configuration. As shown in FIGS. 3G and 3H, as the second adjustable handle arm 212 of the adjustable handle 209 is rotated in the clockwise direction about an axis of rotation defined by the pivot coupling means 214 and the first adjustable handle arm 210 is rotated in the same direction about the other pivot coupling means 215, the guide pin 246 moves up the elongated slot 244 of the second adjustable handle arm 212 in the “B” direction and simultaneously moves along the elongated slot 250 of the second side member 206 in the “A” direction. In addition, in example embodiments where two adjustable handle arms are used for the adjustable handle 209, the guide pin 242 moves up the elongated slot 240 of the first adjustable handle arm 210 in the “B” direction and simultaneously moves along the elongated slot 208 of the first side member 204 in the “A” direction.

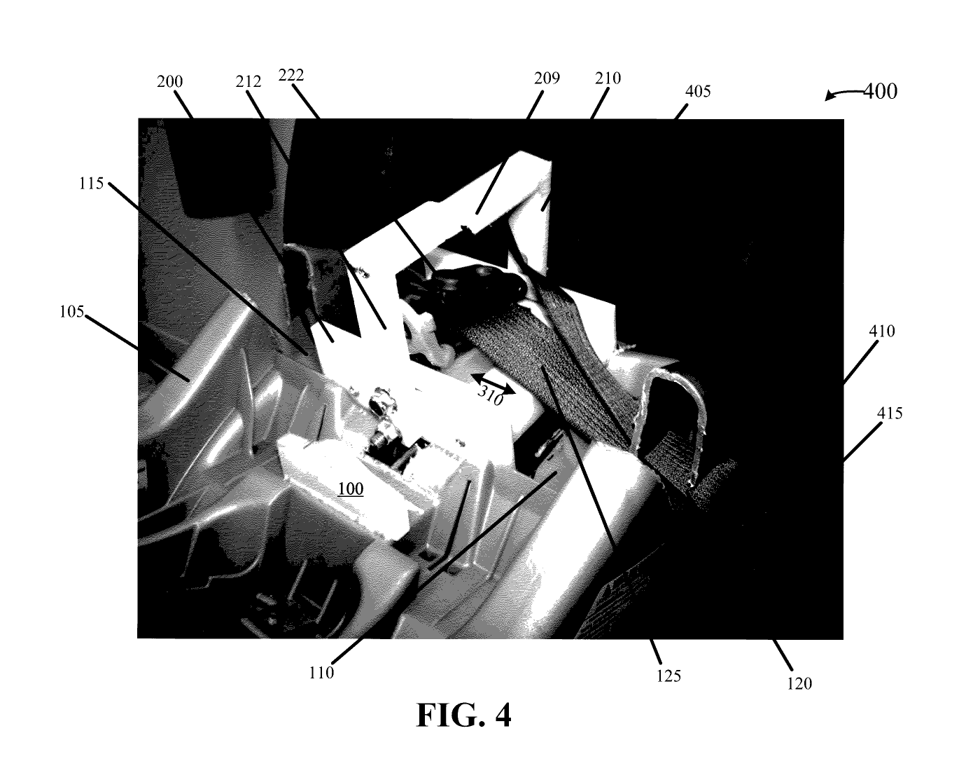

The movement of each guide pin 242, 246 along the corresponding pair of elongated slots 208, 240 and 250, 244, causes, due to the coupling of the guide pins 242, 246 either directly or indirectly to the belt lock-off device 222, a corresponding movement of the belt lock-off device 222 in the direction “C” across the top surface of the base member 202 and in a direction parallel or substantially parallel to the belt pathway 310. In one example embodiment, the force needed to move the adjustment handle 209 in the clockwise direction is typically greater than the force of the one or more spring biasing devices that bias the adjustable handle arms 210, 212 into the initial, centered position. The end of the vehicle seat belt 125 opposite the latch 415 (FIG. 4) (on the other side of the child car seat to which the seat belt tensioning apparatus 200 may be incorporated) can be typically fixed or anchored to the vehicle floor or vehicle frame. Thus, the portion of the vehicle seat belt 125 between the anchor point and the seat belt tensioning apparatus 200 (which is clamped onto the vehicle seat belt 125) will be under increased tension applied by the seat belt tensioning apparatus 200 moving the belt lock-off device 222 in the direction “C”. This increased tension will more securely hold the child car seat or child car seat base against the vehicle seat, resulting in little to no movement of the child car seat or child car seat base.

Though not shown herein, the adjustment handle 209 (e.g., one or both of the adjustment handle arms 210, 212) can be locked in the initial or centered position, when rotated in the clockwise direction from the initial position, when rotated in the counter-clockwise direction from the initial position, or all three, in any number of ways. The adjustment handle 209 (e.g., one or both of the adjustment handle arms 210, 212) can include an over-center device or arrangement whereby the adjustment handle 209 (e.g., one or both of the adjustment handle arms 210, 212) would feed toward the selected position upon reaching the over-center condition. In other example embodiments, the seat belt tensioning apparatus 200 can include any number of lock devices, detents, key and way devices, VALCO ball devices, buttons, levers, or the like to retain and/or release the adjustment handle 209 (e.g., one or both of the adjustment handle arms 210, 212), as desired.

As shown in FIG. 31, as the second adjustable handle arm 212 of the adjustable handle 209 is rotated in the counter-clockwise direction about an axis of rotation defined by the pivot coupling means 214 and the first adjustable handle arm 210 is rotated in the same direction about the axis or rotation defined by the other pivot coupling means 215, the guide pin 246 moves up the elongated slot 244 of the second adjustable handle arm 212 in the “Z” direction and simultaneously moves along the elongated slot 250 of the second side member 206 in the “W1” direction. In addition, in example embodiments where two adjustable handle arms are used for the adjustable handle 209, the guide pin 242 moves up the elongated slot 240 of the first adjustable handle arm 210 in the “Z” direction and simultaneously moves along the elongated slot 208 of the first side member 204 in the “W2” direction.

The movement of each guide pin 242, 246 along the corresponding pair of elongated slots 208, 240 and 250, 244, causes, due to the coupling of the guide pins 242, 246 either directly or indirectly to the belt lock-off device 222, a corresponding movement of the belt lock-off device 222 in the direction “W3” across the top surface of the base member 202 and in a direction parallel or substantially parallel to the belt pathway 310. In one example embodiment, the force needed to move the adjustment handle 209 in the counter-clockwise direction away from the initial position is typically greater than the force of the one or more spring biasing devices that bias the adjustable handle arms 210, 212 into the initial, centered position. The ability to move the belt lock-off device 222 in two opposing directions along the belt pathway 310 provides the seat belt tensioning apparatus 200 with the ability to tension different types of vehicle seat belts 125 as well as tension those seat belts 125 in different directions depending on the positioning of the seat belt 125 and the latch (not shown) with respect to the seat belt tensioning apparatus 200 and the child car seat or child car seat base.

As discussed above, the example seat belt tensioning apparatus 200 can be incorporated into any form of child car seat, including but not limited to a child car seat base, a forward-facing child car seat, a rearward facing child car seat, and a toddler seat. FIG. 4 illustrates an example system 400 that includes the seat belt tensioning apparatus 200 incorporated into a child car seat base 100 according to one example embodiment of the disclosure. As shown in FIG. 4, the vehicle's dedicated seat belt will hang from one side of the child car seat base 100 and the latch or buckle housing 415 of the vehicle seat belt system will typically be on the other side of the child car seat base 100. In one example embodiment, the seat belt tensioning apparatus 200 is coupled to the molded seat shell frame 105 of the child car seat base 100. For example, the seat belt tensioning apparatus 200 can be coupled to the base 100 between the first belt path opening 115 and the second belt path opening 120 along the belt pathway 110 such that the belt pathway 310 of the seat belt tensioning apparatus 200 is parallel or substantially parallel to the belt pathway 110 of the base 100. In one example, the seat belt tensioning apparatus 200 is coupled to the base 100 using known coupling devices (e.g., screws, nails, bolts, rivets, adhesive, etc.). Alternatively, all or a portion of the seat belt tensioning apparatus 200 can be integrally formed with the molded seat shell frame 105 of the child car seat base 100.

The lap belt portion and the sash or shoulder belt portion 405 are typically joined to one another at a latch plate 410 of vehicle seat belt 125. In one example, a user can grasp the latch plate 410 and thread the latch plate 410, lap belt portion and sash or shoulder belt portion 405 of the vehicle seat belt 125 through or under the adjustable handle 409. The sash or shoulder belt portion 405 can be re-routed by passing it through the split 207 in the handle grips 216, 218, when and as needed to properly position the shoulder belt portion 405 relative to the child seat occupant. The lap belt portion of the vehicle seat belt 125 can then be inserted into the belt lock-off device 222 over the top surface of the receiving member 226. When the lap portion of the vehicle seat belt 125 is placed within the belt lock-off device 222 the sash or shoulder belt portion 405 of the seat belt can be positioned between the adjustable handle 209 and the belt lock-off device 222 but not within the belt lock-off device 222. The latch plate 410 of the vehicle seat belt 125 can be removably coupled to the latch 415 of the vehicle. The spring return of the seat belt 125 will place some tension on the seat belt. The seat belt tensioning apparatus 200 can then be used to generate increased tension in the seat belt 125 used to hold the child car seat base 100 in place along a top surface of a vehicle seat in substantially the same manner as that described above in FIGS. 3A-3I.

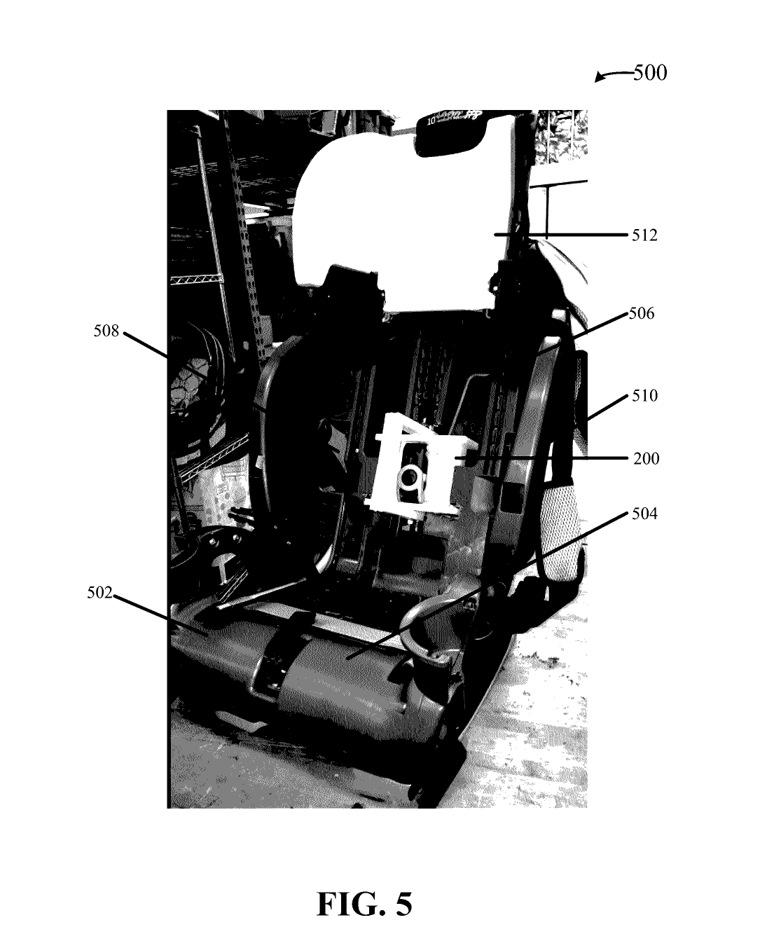

FIG. 5 illustrates an example system 500 that includes the example vehicle seat belt tensioning apparatus 200 incorporated into a child car seat 502 according to one example embodiment of the disclosure. As shown in FIG. 5, the child car seat 502 can include a seat base 504, a seat back 506, and a seat headrest 512. In one example, the seat back 506 can include a first belt path opening 508 and a second belt path opening 510. The seat belt tensioning apparatus 200 can be coupled to the seat back 506 or the seat base 504 generally between the first belt path opening 508 and the second belt path opening 510. In one example embodiment, the seat belt tensioning apparatus 200 can be coupled to the seat back 506 or the seat base 504 using known coupling devices (e.g., screws, nails, bolts, rivets, adhesive, etc.). The seat belt tensioning apparatus 200 can then be used to generate increased tension in a vehicle seat belt 125 used to hold the child car seat 502 in place along a top surface of a vehicle seat in substantially the same manner as described above in FIGS. 3A-3I.

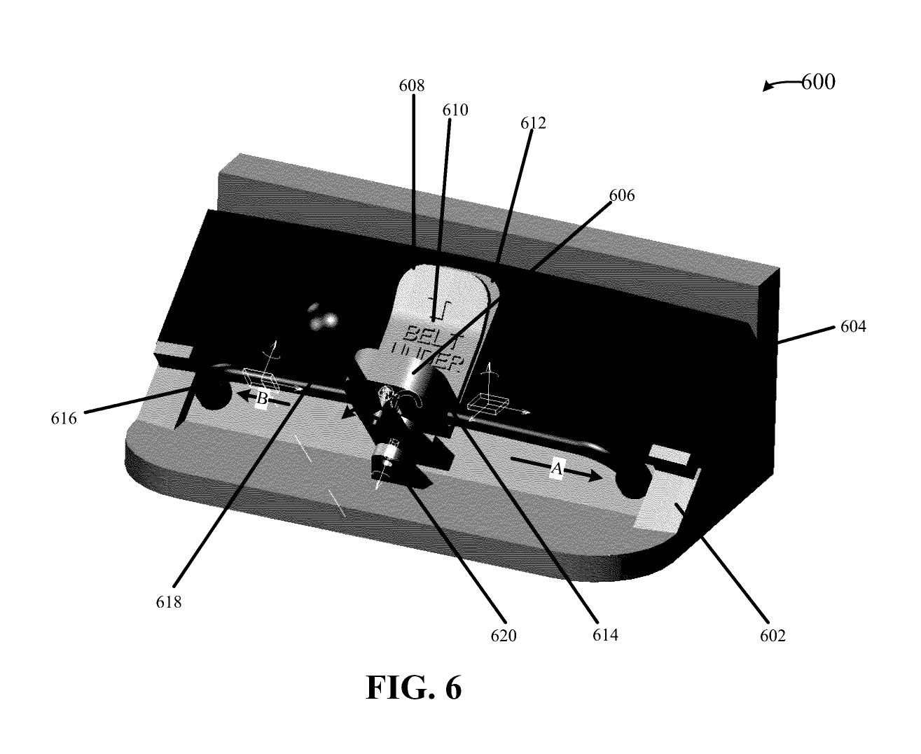

FIG. 6 illustrates another vehicle seat belt tensioning apparatus 600 according to another example embodiment of the disclosure. Referring now to FIG. 6, the seat belt tensioning apparatus 600 can include a base 602 and a belt pathway 604 disposed along a top surface of the base 602. In one example, the belt pathway 604 extends from a first end of the base 602 to a second opposing end of the base 602. In one example, the belt pathway 604 has a smooth or substantially smooth surface to allow a seat belt 125 to slide over the belt pathway 604 with minimal friction.

The seat belt tensioning apparatus 600 can also include a belt lock-off device 606 movably coupled to an adjustment handle 618 and an adjustment rail 616. In one example, the belt lock-off device 606 can include a top clamping member 610 and a bottom clamping member 612 integrally formed with or coupled to the belt lock-off device 606. In certain example embodiments, the belt lock-off device is configured to be positioned along a seat belt path. In one example embodiment, the top clamping member 610 and the bottom clamping member 612 are planar or substantially planar members disposed in close proximity to one-another and spring biased to be in contact with one-another. The top clamping member 610 and the bottom clamping member 612 can include an opening 608 therebetween that is configured to receive at least a portion of the seat belt 125. In certain example embodiments, each of the bottom surface of the top clamping member 610 and the top surface of the bottom clamping member 612 can include a friction enhancing material layer, such as a rubber, silicone, or other material with a tacky surface to increase the friction level of the respective bottom and top surfaces and improve the ability of each to hold the seat belt therein when placed therebetween.

The belt lock-off device 606 can also include a rail channel 614 extending through the body of the belt lock-off device 606 and configured to receive the lock-off adjustment rail 616 therethrough, such that the belt lock-off device 606 is slidably coupled to the lock-off adjustment rail 616. The base 602 can also include a handle mount 620. The adjustment handle 618 can be rotatably coupled to the handle mount 620 and the handle mount can define an axis of rotation for the adjustment handle 618. In one example, the axis of rotation is defined by a mounting pin that couples the handle 618 to the handle mount 620. In one example embodiment, the handle mount 620 can include a spring or other biasing device to spring bias the adjustment handle into an initial position. In one example, the initial position is a centered position, and the adjustment handle 618 can be rotated both clockwise and counter-clockwise about the axis of rotation. In one example, when the adjustment handle 618 is rotated in the clockwise direction, it causes a corresponding movement of the belt lock-off device 606 along the lock-off adjustment rail 616 and along the belt pathway 604 in the “A” direction. In another example, when the adjustment handle 618 is rotated in the counter-clockwise direction, it causes a corresponding movement of the belt lock-off device 606 along the lock-off adjustment rail 616 and along the belt pathway 604 in the “B” direction. The belt lock-off device 606 can lock onto, latch onto, squeeze, crimp, or otherwise grab any portion of the lock-off adjustment rail 616 when the handle moves the belt lock-off device 606 in the clockwise or counter-clockwise direction. In certain example embodiments, the belt lock-off device 606 can be locked and released from the lock-off adjustment rail simply by moving the adjustment handle 618 or the belt lock-off device can include a separate lock and/or release device, button, lever, or the like. In another example embodiment, the base 602 or belt lock-off device 606 can include a mechanism that can lock and/or retain or hold the belt lock-off device 606 in a locked or tensioned position or that can unlock and/or release to allow the belt lock-off device 606 and adjustment handle 618 to move or return to an initial or centered position.

Although example embodiments of the disclosure have been described, one of ordinary skill in the art will recognize that numerous other modifications and alternative embodiments are within the scope of the disclosure. Furthermore, while various example implementations and architectures have been described in accordance with example embodiments of the disclosure, one of ordinary skill in the art will appreciate that numerous other modifications to the example implementations and architectures described herein are also within the scope of this disclosure.

Certain aspects of the disclosure are described above with reference to example methods of use of the seat belt tensioning apparatus. It will be understood that one or more steps of the described example methods may not necessarily need to be performed in the order presented, or may not necessarily need to be performed at all, according to some embodiments. Further, additional components and/or operations beyond those depicted in example methods may be present in certain embodiments.

Although example embodiments have been described in language specific to structural features and/or methodological acts, it is to be understood that the disclosure is not necessarily limited to the specific features or acts described. Rather, the specific features and acts are disclosed as illustrative forms of implementing the example embodiments. Conditional language, such as, among others, “can,” “could,” “might,” or “may,” unless specifically stated otherwise, or otherwise understood within the context as used, is generally intended to convey that certain example embodiments could include, while other example embodiments do not include, certain features, elements, and/or steps. Thus, such conditional language is not generally intended to imply that features, elements, and/or steps are in any way required for one or more embodiments.

What is claimed is:

1. An apparatus comprising:
a frame comprising a surface profile defining a belt pathway;
a seat belt lock-off device operably coupled to the frame and configured to move along the surface profile of the frame;
an actuator operably coupled to the seat belt lock-off device and configured to move the seat belt lock-off device from a first position to a second position along the surface profile of the frame.

2. The apparatus of claim 1, wherein the seat belt lock-off device comprises:
a receiving member comprising:
a top surface; and
a recessed groove disposed in the top surface;
a clamping member comprising:
a bottom surface; and
a protrusion extending out from the bottom surface, wherein at least a portion of the protrusion is configured to be received in at least a portion of the recessed groove.

3. The apparatus of claim 1, wherein the surface profile extends along a first axis and wherein the recessed groove extends along a second longitudinal axis, wherein the second longitudinal axis is substantially orthogonal to the first axis.

4. The apparatus of claim 2, wherein the clamping member is rotatably coupled to the receiving member and configured to move from an open configuration to a closed configuration.

5. The apparatus of claim 4, wherein the seat belt lock-off device further comprises a spring biasing member coupled to the clamping member, wherein the spring biasing member biases the clamping member in the open configuration.

6. The apparatus of claim 1, wherein the frame comprises:
a base member comprising a first lateral side, an opposing second lateral side, and a top surface extending between the first lateral side and the second lateral side;
a first side member disposed adjacent the first lateral side, at least a portion of the first side member extending in a vertical direction higher than the top surface of the base member;
a second side member disposed adjacent the second lateral side, at least a portion of the second side member extending in the vertical direction higher than the top surface of the base member.

7. The apparatus of claim 6, wherein the seat belt lock-off device comprises a bottom surface, wherein the bottom surface of the seat belt lock-off device slides along the top surface of the base member along the surface profile.

8. The apparatus of claim 7, wherein the top surface of the base member comprises a recessed groove extending along the surface profile and wherein the bottom surface of the seat belt lock-off device further comprises a protrusion sized and shaped to fit within the recessed groove of the top surface of the base member.

9. The apparatus of claim 6, wherein the frame is integrally formed with a child car seat.

10. The apparatus of claim 9, wherein the child car seat is one of a child car seat base, a forward-facing child car seat, a rearward facing child car seat, or a toddler seat.

11. The apparatus of claim 6, wherein the actuator comprises an adjustment handle rotatably coupled to the frame, wherein rotation of the adjustment handle is configured to move the seat belt lock-off device from the first position to the second position along the surface profile of the frame.

12. The apparatus of claim 11, wherein the adjustment handle comprises:
a first adjustment handle arm operably coupled to the seat belt lock-off device, the first adjustment handle arm comprising a first end and a distal second end, wherein the first adjustment handle arm is rotatably coupled to the frame along the first lateral side of the base adjacent the first end of the first adjustment handle arm;
a first handle grip disposed adjacent the second end of the first adjustment handle arm.

13. The apparatus of claim 12, wherein the first adjustment handle arm rotates in a first direction from a third position to a fourth position, wherein the adjustment handle further comprises a spring biasing member biasing the first adjustment handle arm in the third position, wherein rotating the first adjustment handle arm from the third position to the fourth position causes a corresponding movement of the seat belt lock-off device from the first position to the second position along the surface profile of the frame.

14. The apparatus of claim 12, wherein the first adjustment handle arm rotates in a second direction opposite the first direction from the third position to a fifth position, wherein rotating the first adjustment handle arm from the third position to the fifth position causes a corresponding movement of the seat belt lock-off device from the first position to a sixth position along the surface profile of the frame.

15. The apparatus of claim 12, wherein the adjustment handle further comprises:
a second adjustment handle arm operably coupled to the seat belt lock-off device, the second adjustment handle arm comprising a first end and a distal second end, wherein the second adjustment handle arm is rotatably coupled to the frame along the second lateral side of the base adjacent the first end of the second adjustment handle arm;
a second handle grip disposed adjacent the second end of the second adjustment handle arm.

15. An apparatus comprising:
a child car seat;
a base member disposed on the child car seat and comprising a first lateral side, an opposing second lateral side, and a top surface extending between the first lateral side and the second lateral side;
a first side member disposed adjacent the first lateral side, at least a portion of the first side member extending in a vertical direction higher than the top surface of the base member;
a first elongated slot disposed in at least a portion of the portion of the first side member extending in the vertical direction higher than the top surface of the base member;
a second side member disposed adjacent the second lateral side, at least a portion of the second side member extending in the vertical direction higher than the top surface of the base member;
a second elongated slot disposed in at least a portion of the portion of the second side member extending in the vertical direction higher than the top surface of the base member;
a seat belt lock-off device comprising a first end and an opposing second end, the seat belt lock-off device configured to move along a surface profile of the base member;
an actuator rotatably coupled to at least one of the base member and the first side member;
a first guide pin coupled to the first end of the seat belt lock-off device and operably coupled to the actuator, wherein at least a portion of the first guide pin extends through the first elongated slot;
a second guide pin coupled to the second end of the seat belt lock-off device, wherein at least a portion of the second guide pin extends through the second elongated slot;
wherein the actuator is configured to rotate from a first position to a second position, wherein rotation of the actuator from the first position to the second position is configured to cause a corresponding movement of the seat belt lock-off device from a third position to a fourth position along the surface profile of the base member.

16. The apparatus of claim 15, wherein the child car seat is one of a child car seat base, a forward-facing child car seat, a rearward facing child car seat, or a toddler seat.

17. The apparatus of claim 15, wherein the surface profile of the base member is substantially parallel to a vehicle seat belt pathway.

18. The apparatus of claim 15, wherein the actuator comprises:
a first adjustment handle arm comprising:
a first end;
a distal second end,
a third elongated slot extending through the first adjustment handle arm and disposed between the first end and the second end of the first adjustment handle arm;
wherein the first adjustment handle arm is rotatably coupled to at least one of the base member and the first side member adjacent the first end of the first adjustment handle arm and wherein at least another portion of the first guide pin extends through the third elongated slot to operably couple the actuator to the seat belt lock-off device;
a first handle grip disposed adjacent the second end of the first adjustment handle arm.

19. The apparatus of claim 18, wherein the actuator further comprises:
a second adjustment handle arm comprising:
a first end;
a distal second end;
a fourth elongated slot extending through the second adjustment handle arm and disposed between the first end and the second end of the second adjustment handle arm;
wherein the second adjustment handle arm is rotatably coupled to at least one of the base member and the second side member adjacent the first end of the second adjustment handle arm and wherein at least another portion of the second guide pin extends through the fourth elongated slot.

20. The apparatus of claim 15, wherein the seat belt lock-off device comprises:
a receiving member comprising:
a top surface; and
a recessed groove disposed in the top surface;
a clamping member rotatably coupled to the receiving member, the clamping member comprising:
a bottom surface; and
a protrusion extending out from the bottom surface, wherein at least a portion of the protrusion is configured to be received in at least a portion of the recessed groove.
